(19) United States
(12) Patent Application Publication
(10) Pub. No.: US 2018/0245638 A1
(43) Pub. Date: Aug. 30, 2018

(54) METHOD FOR COATING A COMPONENT

(71) Applicant: Caterpillar Inc., Peoria, IL (US)

(72) Inventors: Daniel Joseph Sordelet, Peoria, IL (US); Daniel Thomas Cavanaugh, Chillicothe, IL (US)

(73) Assignee: Caterpillar Inc., Peoria, IL (US)

(21) Appl. No.: 15/444,415

(22) Filed: Feb. 28, 2017

(51) Int. Cl. F16C 33/14; C23C 4/06; C23C 4/134; C23C 4/126; C23C 4/131; C23C 4/129; C23C 4/18

(52) U.S. Cl. CPC F16C 33/14; C23C 4/06; C23C 4/134; C23C 4/126; F16C 2223/06; C23C 4/129; C23C 4/18; F16C 2223/42; C23C 4/131

(57) ABSTRACT

A method for coating a component, the method including the steps of depositing, by a thermal spraying process, simultaneously a first material and a second material on a surface of the component to form a rough coating, wherein the first material is of higher hardness than the second material and removing a layer of the rough coating such that the second material plastically deforms and produces a finished coating having a finished surface with an Rz value of less than 2 μm.

### TECHNICAL FIELD

The present disclosure generally relates to coatings. More particularly, the present disclosure relates to a method of forming a coating having a surface roughness below a predefined surface roughness value.

### BACKGROUND

Thermal spray coatings are frequently used to impart new property to a component's surface. For example, spray coatings may be used on worn components to restore their dimensions, sealing ability, and/or other material properties. All spray coating techniques have a common characteristic wherein they define some internal porosity within the coatings.

Subsequent to deposition of the coating on the component, the coating may be subjected to finishing processes such as lathe turning, milling, honing, grinding, polishing, etc. These finishing processes may expose internal pores of the coating, thereby creating valleys or depressions of large sizes on the final external surface of the coating. Such large size valleys and depressions may impact the performance of the coating or of the component.

For example, in salvaging journal bearing surfaces, too high of an Rz (the difference between the deepest depression and the tallest peak) value is often thought to lead to failure via cavitation erosion when oil is trapped in the valleys and is subjected to cyclic liquid pressure fluctuations, which generate cavitation. In other applications such as hydraulic cylinder rods, coatings with too high of Rz can damage polymeric seals, leading to catastrophic leakage. Accordingly, for optimal operation of the components, it is necessary to reduce the size and frequency of these peaks-to-valley dimensions.

U.S. Pat. No. 6,305,459 discloses thermally spraying bulk material on a target surface. U.S. Pat. No. 6,305,459 further discloses that subsequent coatings of different materials are applied on the target surface to reduce porosity levels in the sprayed layers. This results in the need for multiple coatings to be applied in multiple steps, thus increasing costs.

### SUMMARY OF THE INVENTION

In an aspect of the present disclosure, a method for coating a component is disclosed. The method comprising the steps of depositing, by a thermal spraying process, simultaneously a first material and a second material on a surface of the component to form a rough coating, wherein the first material is of higher hardness than the second material and removing a layer of the rough coating such that the second material plastically deforms and produces a finished coating having a finished surface with an Rz value of less than 2 μm.

In another aspect of the present disclosure, a component is disclosed. The component includes a coating including a first material mixed with a second material, the first material being of higher hardness than the second material, wherein the coating has a finished surface having an Rz value of less than 2 μm.

In another aspect of the present disclosure, a journal bearing having a coating is disclosed. The coating is formed by a process comprising the steps of depositing, by a thermal spraying process, simultaneously a first material and a second material on a surface of the journal bearing to form a rough coating, wherein the first material is of higher hardness than the second material and removing a layer of the rough coating such that the second material plastically deforms and produces a finished coating having a finished surface with an Rz value of less than 2 μm.

### BRIEF DESCRIPTION OF THE DRAWINGS

FIG. 1 is a diagrammatic illustration of a twin wire arc process for thermally spraying and depositing a coating on a component;

FIG. 2 is a diagrammatic illustration of a thermal spraying process using a powder feedstock to coat a component;

FIG. 3 illustrates the coated component and the grain structure of the rough coating;

FIG. 4 illustrates the 2D surface profilometry of the rough coating deposited on the component;

FIG. 5 is a diagrammatic illustration of the rough coating undergoing a finishing process in accordance with an embodiment of the present disclosure;

FIG. 6 illustrates the finished coating and the grain structure of the finished coating after completion of the finishing process;

FIG. 7 illustrates the 2D surface profilometry of the finished coating applied on the component after completion of the finishing process in accordance with an embodiment of the present disclosure; and

FIG. 8 depicts a method of coating a component in accordance with an embodiment of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts.

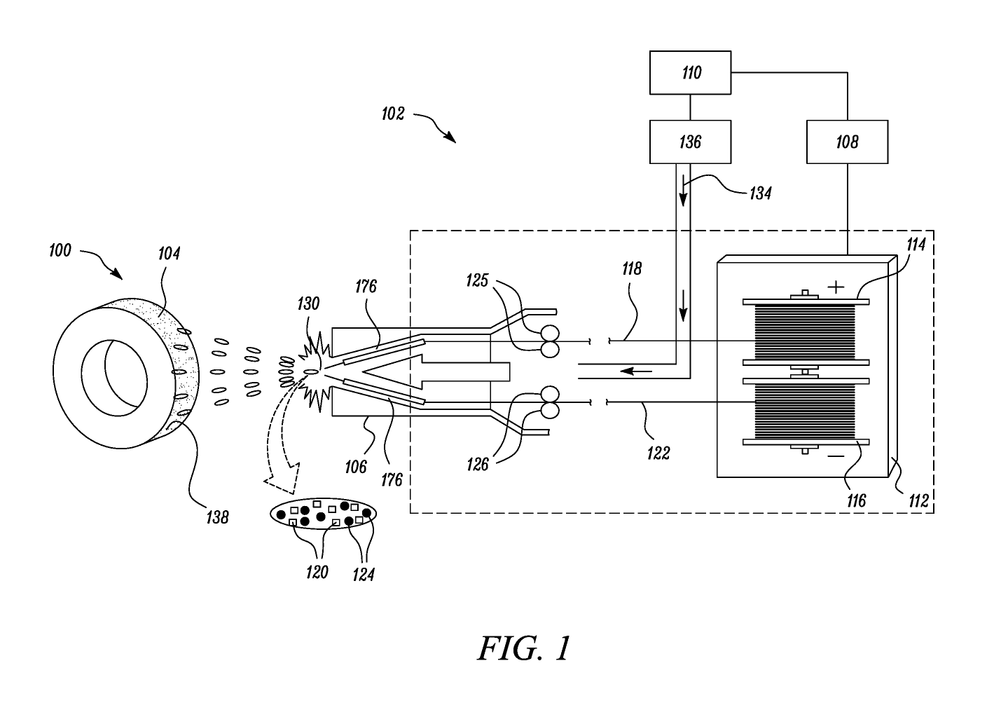

FIG. 1 illustrates an exemplary component 100 having a surface 104. The component 100 may be a machine part and may be configured to perform a specific operation either alone or when assembled with another component. For example, in the embodiment illustrated in FIG. 1, the component 100 is a journal bearing configured to constrain relative motion to only a desired motion, and reduce friction between moving parts. In another example, the component 100 may be a hydraulic cylinder rod configured to move back and forth within a cylinder. In various other examples, the component 100 may be a structural component such as, but not limited to, a piston, a gear, a bushing, a pin, a valve, a cam and a shaft.

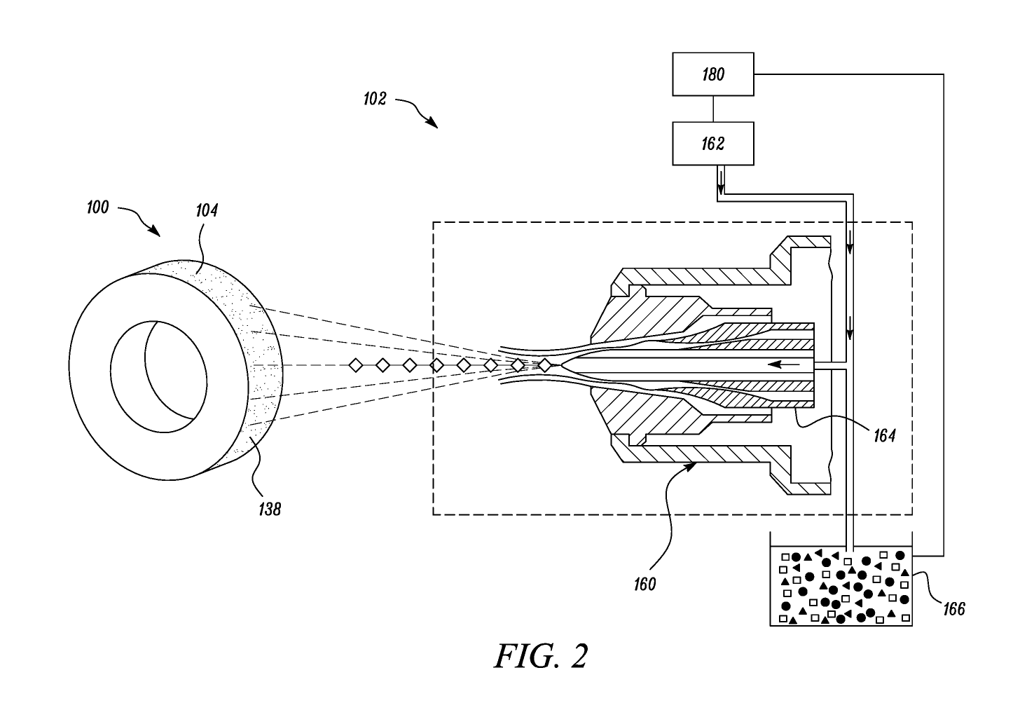

The component 100 may be subjected to wear and tear during operation. The present disclosure provides for a method of enhancing the wear resistance and enhancing life of the component 100 by depositing a coating on the surface 104 of the component 100 via a thermal spray system 102, as illustrated in FIG. 1 and FIG. 2.

As illustrated in FIG. 1, the thermal spray system 102 may include a spray gun 106, an energy source 108, a control console 110 and a wire feed device 112. The wire feed device 112 may include a first spool 114 made up of a first wire 118 of a first material 120. The wire feed device 112 may further include a second spool 116 made up of a second wire 122 of a second material 124. The wire feed device 112 may be configured to provide the first wire 118 of first material 120 and the second wire 122 of second material 124 to the spray gun 106.

The spray gun 106 may include feed rollers 125, 126 configured to pull the first wire 118 and the second wire 122 from the first spool 114 and the second spool 116 respectively. The first wire 118 and the second wire 122 fed to the spray gun 106 may be coupled to the energy source 108. The energy source 108 may be configured to energize the first wire 118 and the second wire 122 such that opposing polarities may be developed in the first wire 118 and the second wire 122.

The control console 110 may be operatively coupled to the feed rollers 125, 126. The control console 110 may be configured to control the wire feed rate, i.e., the speed at which the first wire 118 and the second wire 122 may be fed into channels 176 of the spray gun 106. The control console 110 may further be operatively coupled to the energy source 108 and may be configured to actuate the energy source 108 such that current is passed by the energy source 108 to the first wire 118 and the second wire 122.

Upon being actuated, the energy source 108 causes opposing polarities to develop in the first wire 118 and the second wire 122. Due to the opposing polarities, an arc may be struck between the first wire 118 and the second wire 122 at an arc point 130, i.e., location at which the first wire 118 and the second wire 122 come into contact and electrically arc based on electric current therein. The arc generated causes the first wire 118 and the second wire 122 to melt and form a mixture of first material 120 and second material 124 at the arc point 130. At the arc point 130, the mixture of first material 120 and the second material 124 commingle to form a blend/mixture of coating material. Further, at the arc point, the first material 120 and the second material 124 mix such that the first material 120 and the second material 124 are uniformly distributed in the mixture of coating material.

The thermal spray system 102 may further include a propelling gas 134 stored in a propelling gas source 136. The propelling gas 134 may be configured to propel the mixture of coating material generated at the arc point 130 to the surface 104 of the component 100 to form a rough coating 138. In an embodiment, the propelling gas 134 may include a compressed gas, for example argon. However, in another example, the propelling gas 134 may take the form of a combustion-based gas such as that created by a high velocity oxygen fuel (HVOF) process using hydrogen gas or a liquid fuel like kerosene.

In the embodiment, illustrated in FIG. 1, the surface 104, where the rough coating 138 is applied, constitutes the external surface (the surface along the external diameter) of the component 100. However, it may be contemplated that the rough coating 138 can be applied/deposited on any surface of the component 100. For example, the rough coating 138 may be deposited on a surface formed along the inner/internal diameter of the component 100.

The rough coating 138 applied/deposited to the surface 104 of the component 100 may be configured to impart a new functionality/property or improve the wear resistance to a component's 100 surface 104. For example, the rough coating 138 may be applied on a comparatively softer component 100 thereby imparting strength and hardness to the component 100. In an alternate example, the component 100 may be used in harsh environments of high temperature (more than 300 degrees Celsius). Layer of heat resistant rough coating 138 may be applied over the component 100 to prolong component 100 life and prevent the negative effects of the harsh temperatures on the component 100.

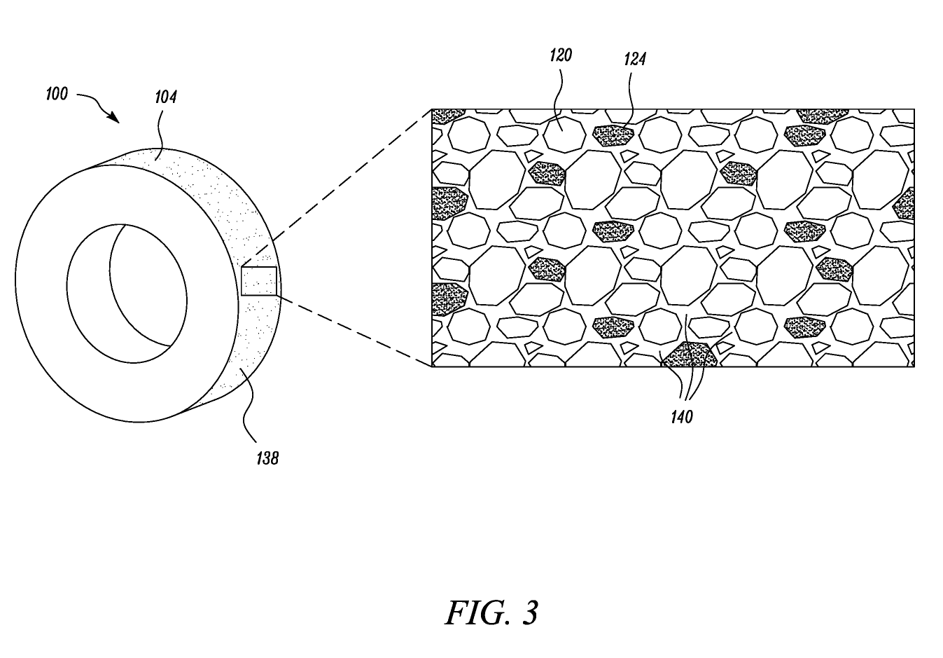

The rough coating 138 as deposited by the thermal spray system 102 of FIG. 1 has an interstitial structure as shown in FIG. 3. The rough coating 138 applied/deposited onto the component 100 is a mixture of uniformly interspersed particles of the first material 120 and the second material 124 as shown in FIG. 3. The first material 120 and the second material 124 do not fuse together to form an alloy. The first material 120 particles and the second material 124 particles remain in their original state in the rough coating 138 and retain their original properties.

The first material 120 of the rough coating 138 has a comparatively higher hardness value as compared to the second material 124. For example, in the embodiment illustrated in FIG. 3, the rough coating 138 has Stellite 1 as the first material 120 and brass as the second material 124 (Stellite 1 being harder than brass).

The first wire 118 (made of the first material 120) may have a Vickers hardness value of more than 500 HV300 (Vickers microhardness measured with a 300 g load) and may for example be any one of Inconel 625, 420 stainless steel, Tafa 90 MXC, Tafa 95 MXC, Tafa 96 MXC, Tafa 140 MXC, nanosteel SHS 9193W16, Nanosteel SHS 717, Nanosteel SHS 9192W16 and Oerlikon Metco 8222. Further, the second wire 122 (made of comparatively softer second material 124) may have a Vickers hardness of not more than 250 HV300 and may for example be any one of Tafa 01T (Al) Tafa O1A (Al-12Si), Tafa O2Z (Zn), Tafa 80T (304 stainless), Tafa 85T (316 stainless), Tafa O5T (copper), babbit, brass, nickel and aluminium.

Referring to FIG. 3, the rough coating 138 may also include pores/pockets 140 of empty spaces present within the rough coating 138. The pores 140 may be present throughout the rough coating 138 and may be interspersed throughout the mixture of first material 120 and second material 124, as illustrated in FIG. 3. The pores 140 may be formed when the rough coating 138 is being deposited over the surface 104 of the component 100.

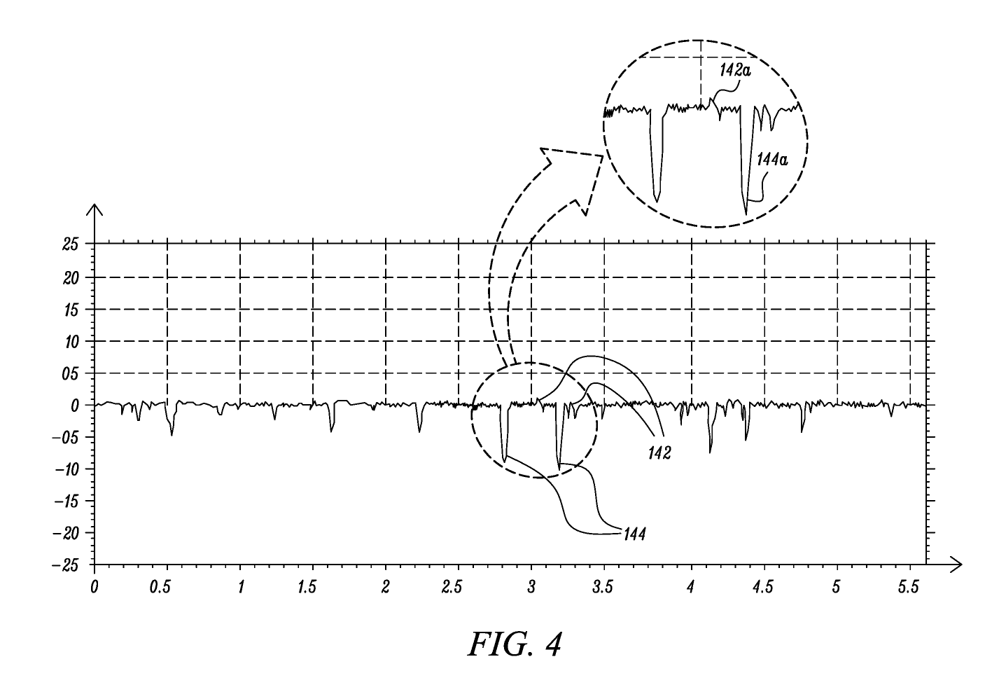

FIG. 4 illustrates a 2D surface profilometry of the rough coating 138 (of FIG. 3) as applied over the component 100. Surface finish of the rough coating 138 includes a plurality of peaks 142 and a plurality of depressions 144, as illustrated in FIG. 4. The plurality of peaks 142 and the plurality of depressions 144 include one or more peaks and one or more depressions of high magnitude respectively. For example, reference numerals 142a and 144a refer to a high magnitude peak and depression respectively. This rough coating 138 (illustrated in FIG. 3) having a surface finish including the plurality of peaks 142 and the plurality of depressions 144 as depicted in FIG. 4 undergoes a finishing process.

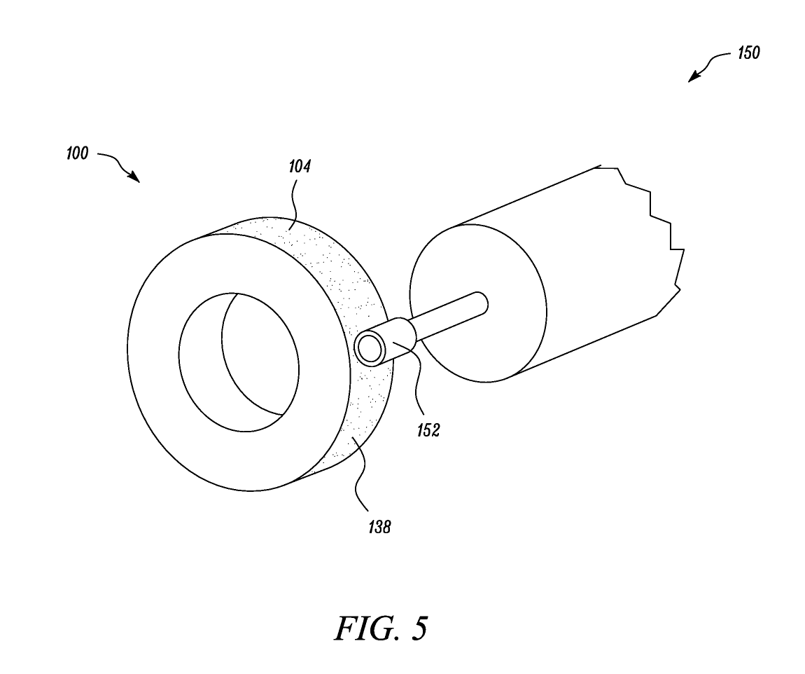

The finishing process includes removal of a layer of the rough coating 138. FIG. 5 illustrates a finishing process being carried out over the rough coating 138. The finishing process may be any one of, but not limited to, lathe turning, milling, honing, grinding, polishing, etc. In the embodiment illustrated in FIG. 5 the finishing process is a grinding process. FIG. 5 illustrates a grinding machine 150 configured to finish the rough coating 138 deposited on the surface 104 component 100. The grinding machine 150 includes a grinding roller 152 configured to rotate and perform the grinding operation over the rough coating 138.

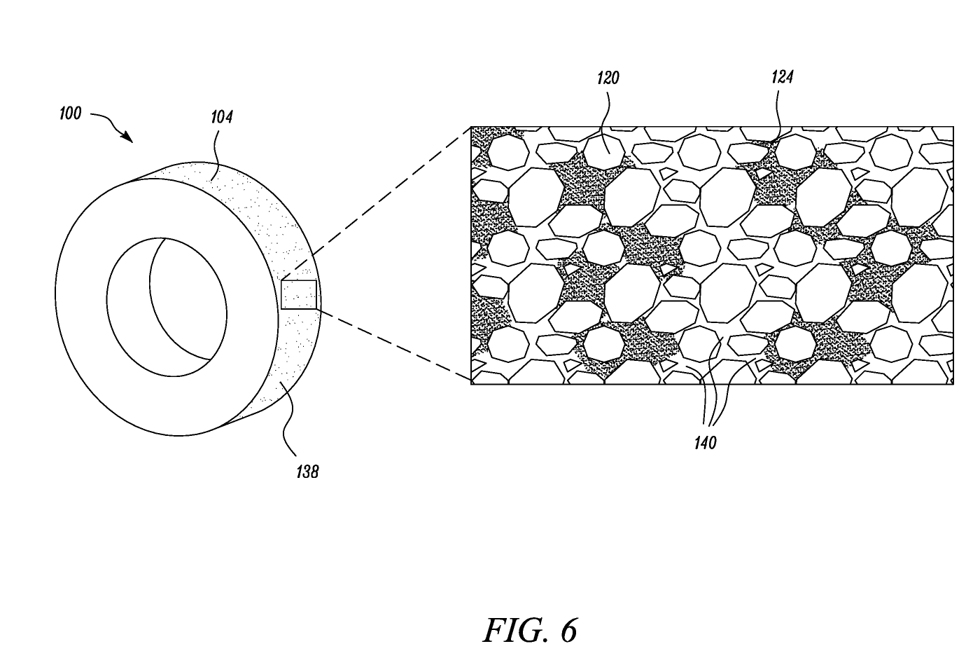

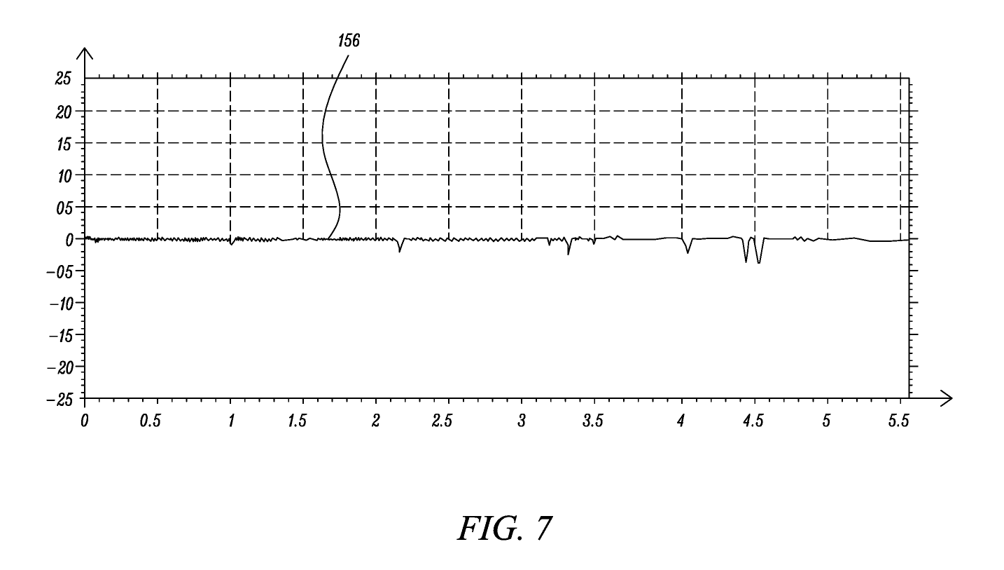

The rotating grinding roller 152 comes in contact with the rough coating 138, as illustrated in FIG. 5, and causes the rough coating 138 to erode, thereby facilitating removal of a layer of the rough coating 138. As discussed above, the rough coatings 138 possesses internal porosity in the form of pores 140. Thus, removal of the layer of the rough coating 138 exposes the pores 140 to the external surface of the machined rough coating 138. However, during the finishing process the conditions around the machined rough coating 138 are such that the soft second material 124 particles, interspersed within the first material 120, smear/plastically deform to fill in the pores 140 (as illustrated in FIG. 6), thereby creating a finished coating 154 with finished surface 156 having an Rz value of less than 2 μm (as illustrated in FIG. 7). The Rz value referenced herein is a ten point height, i.e., the average absolute value of the five highest peaks and the five lowest depressions throughout the evaluation length.

Rz={(P1+P2+P3+P4+P5)−(D1+D2+D3+D4+D5)}/5

FIG.7 illustrates the finished surface 156 of the finished coating 154 (in this example made of 50 percent Stellite and 50 percent brass). The finished coating 154 has an Rz value of 1.6 μm over a length of 5.797 mm. This low Rz value provides a finished surface 156 configured to prevent accumulation of oils within the gaps on the surface of the finished coating 154 and prevents breakage of seals. The low Rz value is achieved by smearing of the second material 124 within the pores 140 exposed to the external surface of the machined rough coating 138. The smearing/plastic deformation within the pores 140 reduces the difference between the peaks and the depressions on the finished surface 156 of the finished coating 154 and produces a finished surface with Rz less than 2 μm.

As illustrated in FIG. 1, FIG. 3-FIG. 7, the rough coating 138 and the finished coating 154 includes two materials, i.e., the first material 120 and the second material 124. The first material 120 and the second material 124 are provided via the first wire 118 and the second wire 122 respectively. In the embodiment illustrated, the first wire 118 and the second wire 122 may be fed at the same speed to the spray gun 106. The first wire 118 and the second wire 122 may have even the same wire diameters. Accordingly, the rough coating 138 and the finished coating 154 may include the first material 120 and the second material 124 in the ratio of 1:1. In various other embodiments, the diameter of the first wire 118 and the second wire 122 may be varied to form the rough coating 138 and the finished coating 154 with different percentage composition. For example, the first wire 118 made up of the first material 120 may have a diameter of 2D and the second wire 122 made up of the second material 124 may have a diameter of D. This combination would yield a rough coating 138 and the finished coating 154 having a composition wherein 66.67 percent is the first material 120 and 33.33 percent is the second material 124.

The thermal spray system 102 as illustrated in FIG. 1 is an arc spray system. However, in an alternate embodiment as illustrated in FIG. 2, the thermal spray system 102 may be a powder feedstock spray system such as plasma spraying, high velocity oxy-fuel spraying (HVOF), high velocity air-fuel (HVAF), detonation spraying, flame spraying, and cold spraying. The thermal spray system 102, as illustrated in FIG. 2, may include a powder feedstock spray gun 160, a carrier gas source 162, a burner system 164, a powder feeding device 166 and a controller 180.

The powder feeding device 166 may be a reservoir having a mixture of first powder made of first material (depicted by solid circles) and a second powder made of a second material (depicted by hollow squares). The first material is of higher hardness than the second material. The first material powder may be a powder of any one of tungsten carbide (WC), chromium carbide (Cr₂C₃), aluminium oxide (Al₂O₃), zirconium Oxide (ZrO₂), chromium oxide (Cr₂O₃), Stellite alloys and high-Cr/Ni stainless steel alloys such as NAH 3.5, Ni-based alloys containing Cr, Si & B such as Diamalloy 2001 and tool steel powders like M2. The second material powder may be a powder of any one of Co, Ni, Cu, bronze, brass, monel or NiCr.

The controller 180 may be operatively coupled to the carrier gas source 162, and the powder feeding device 166. The controller 180 may be configured to control the amount of powder mixture (mixture of first material and second material) and the amount of carrier gas sent to the burner system 164. Thus, when actuation signals from the controller 180 are transmitted to the carrier gas source 162, and the powder feeding device 166, the burner system 164 is fed with the powder (mixture of first material and second material) from the powder feeding device 166 and with a carrier gas and a burnable gas mixture (from the carrier gas source 162). When the carrier gas along with the powder and the burnable gas mixture are ignited in the burner system 164, the hot combustion gases together with the propelling gas are accelerated to a supersonic velocity. At the same time the hot combustion gases partially melt the powder particles (i.e. the mixture of first material and the second material) and mix them together to form a coating material. When this partially melted coating material hits the surface 104 of the component 100 it adheres to the surface 104 to form a rough coating 138. The coating process is carried out until the rough coating 138 attains a desired thickness.

The rough coating 138 deposited on the surface 104 of the component 100 may have a thickness of not less than 50 μm. A thickness value of at least 50 μm of the rough coating 138 ensures that even after the removal of a layer of rough coating 138 during a finishing operation of the rough coating 138, an adequate thickness of the finished coating 154 remains.

The rough coating 138 formed by the thermal spray system 102, as illustrated in FIG. 2, may further include a third material (depicted by solid triangles) in the powder mixture (present in the powder feeding device 166). The third material may also be interspersed within the rough coating 138 and may further improve the wear resistance/strength of the rough coating 138. It may be contemplated that the powder feeding device 166 may include a plurality of materials besides the first material 120 and the second material 124 to enhance the durability and the robustness of the finished coating 154.

### INDUSTRIAL APPLICABILITY

The component 100 may be subjected to wear and tear during operation. This degradation of the surface 104 due to wearing of the component 100 may decrease the life of the component 100 and may also lead to breakdown of the component 100, thereby leading to machine downtime and loss of productivity. One such method of enhancing the wear resistance and enhancing life of components is to deposit a coating on the surface 104 of the component 100 via the thermal spray system 102.

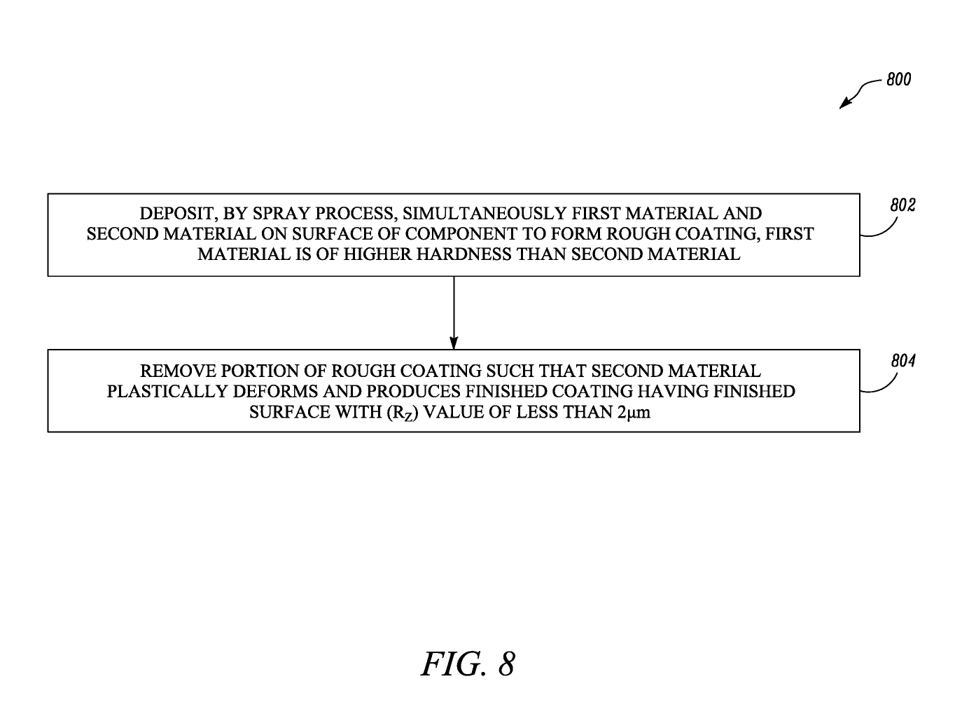

In an aspect of the present disclosure, a method 800 (illustrated in FIG. 8) for coating the component 100 is disclosed. The method 800 includes depositing, by a thermal spraying process, simultaneously the first material 120 and the second material 124 on a surface 104 of the component 100 to form a rough coating 138 (step 802), as illustrated in FIG. 1. The first material 120 is of higher hardness than the second material 124. The method further includes removing a layer of the rough coating 138 such that the second material 124 plastically deforms and produces a finished coating 154 having the finished surface 156 with an Rz value of less than 2 μm (step 804), as illustrated in FIG. 5-7.

The finished coating 154 as disclosed in the present disclosure has an Rz value of less than 2 μm. The finished coating 154 has a smooth surface finish with depressions of low magnitude (as illustrated in FIG. 7). Such coatings may be used on worn out components that are sealed with respect to another component. For example, a worn out hydraulic cylinder piston (having a rough surface with a high Rz value) moving on the internal surface of a hydraulic cylinder may compromise the seal between the piston and the cylinder. This may lead to the liquid sealed within the hydraulic cylinder to leak. The present disclosure provides a method of depositing a coating over such components thereby preventing breakdown of seals. Further, the low Rz value of the surface of the finished coating deposited on the component ensures that the wear and tear during movement of the component is reduced, thus prolonging component life.

In another example, the method may be used to coat a journal bearing. The low surface roughness value of the finished coating deposited over the journal bearing ensures that the finished surface of the coating, deposited over the journal bearing, has depressions of low magnitude. Further, a low surface roughness prevents fluid from being captured/accumulated within the depressions present in the finished coating, thereby preventing the erosion of the finished coating via cavitation during operation of the journal bearing. Accordingly, the wear resistance and the life of the journal bearing may be enhanced. Hence, coating the component 100 by the method 800 as described in the present disclosure provide significant cost savings for both the manufacturer and the user.

While aspects of the present disclosure have seen particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for coating a component, the method comprising the steps of:
depositing, by a thermal spraying process, simultaneously a first material and a second material on a surface of the component to form a rough coating, wherein the first material is of higher hardness than the second material; and
removing a layer of the rough coating such that the second material plastically deforms and produces a finished coating having a finished surface with an Rz value of less than 2 μm.

2. The method of claim 1 wherein the rough coating has a thickness of at least 50 μm.

3. The method of claim 1 wherein the first material and the second material are mixed together prior to being deposited on the surface of the component.

4. The method of claim 1 wherein the thermal spraying process is one of a plasma spraying process, detonation spraying process, wire-arc spraying process, flame spraying process, high velocity oxy-fuel spraying process (HVOF) process, high velocity air-fuel (HVAF) process, and cold spraying process.

5. The method of claim 1 wherein the first material has a Vickers hardness of at least 500 and the second material has a Vickers hardness no greater than 250.

6. The method of claim 1 wherein the first material is one of Inconel 625, 420 stainless steel, Tafa 90 MXC, Tafa 95 MXC, Tafa 96 MXC, Tafa 140 MXC, nanosteel SHS 9193W16, Nanosteel SHS 717, Nanosteel SHS 9192W16 and Oerlikon Metco 8222) and the second material is one of Tafa 01T (Al) Tafa O1A (Al-12Si), Tafa O2Z (Zn), Tafa 80T (304 stainless), Tafa 85T (316 stainless), Tafa O5T (copper), babbit, brass, nickel and aluminium.

7. The method of claim 1 wherein removal of the layer of the rough coating is done by one of lathe turning, honing, grinding and polishing.

8. A component comprising:
a coating including a first material mixed with a second material, the first material being of higher hardness than the second material, wherein the coating has a finished surface having an Rz value of less than 2 μm.

9. The component of claim 8 wherein the finished surface of the coating is formed by plastically deforming the second material during removal of a layer from the coating.

10. The component of claim 8 wherein the first material has a Vickers hardness of at least 500 and the second material has a Vickers hardness no greater than 250.

11. The component of claim 8 wherein the first material and the second material of the coating are mixed together prior to being deposited on a surface of the component.

12. The component of claim 8 wherein the first material is one of Inconel 625, 420 stainless steel, Tafa 90 MXC, Tafa 95 MXC, Tafa 96 MXC, Tafa 140 MXC, nanosteel SHS 9193W16, Nanosteel SHS 717, Nanosteel SHS 9192W16 and Oerlikon Metco 8222) and the second material is one of Tafa 01T (Al) Tafa O1A (Al-12Si), Tafa O2Z (Zn), Tafa 80T (304 stainless), Tafa 85T (316 stainless), Tafa O5T (copper), babbit, brass, nickel and aluminium.

13. The component of claim 8 wherein the first material is one of tungsten carbide (WC), chromium carbide (Cr₂C₃), aluminium oxide (A1₂O₃), zirconium Oxide (ZrO₂), chromium oxide (Cr₂O₃), Stellite alloys and high-Cr/Ni stainless steel alloys such as NAH 3.5, Ni-based alloys containing Cr, Si & B such as Diamalloy 2001 and tool steel powders like M2 and the second material is one of Co, Ni, Cu, bronze, brass, monel or NiCr.

14. The component of claim 8 wherein the coating is formed by depositing the first material and the second material on a surface of the component using one of a plasma spraying process, detonation spraying process, wire-arc spraying process, flame spraying process, high velocity oxy-fuel spraying process (HVOF) process, high velocity air-fuel (HVAF) process and cold spraying process.

15. A journal bearing having a coating formed by a process comprising the steps of:
depositing, by a thermal spraying process, simultaneously a first material and a second material on a surface of the journal bearing to form a rough coating, wherein the first material is of higher hardness than the second material; and
removing a layer of the rough coating such that the second material plastically deforms and produces a finished coating having a finished surface with an Rz value of less than 2 μm.

16. The journal bearing of claim 15 wherein the first material and the second material of the coating are mixed together prior to being deposited on the surface of the journal bearing.

17. The journal bearing of claim 15 wherein the first material has a Vickers hardness of at least 500 and the second material has a Vickers hardness not greater than 250.

18. The journal bearing of claim 15 wherein the first material and the second material are deposited on the surface of the journal bearing using one of a plasma spraying process, detonation spraying process, wire-arc spraying process, flame spraying process, high velocity oxy-fuel spraying process (HVOF) process, high velocity air-fuel (HVAF) process, and cold spraying process

19. The journal bearing of claim 15 wherein the first material is one of Inconel 625, 420 stainless steel, Tafa 90 MXC, Tafa 95 MXC, Tafa 96 MXC, Tafa 140 MXC, nanosteel SHS 9193W16, Nanosteel SHS 717, Nanosteel SHS 9192W16 and Oerlikon Metco 8222) and the second material is one of Tafa 01T (Al) Tafa O1A (Al-12Si), Tafa O2Z (Zn), Tafa 80T (304 stainless), Tafa 85T (316 stainless), Tafa O5T (copper), babbit, brass, nickel and aluminium.

20. The journal bearing of claim 15 wherein the first material is one of tungsten carbide (WC), chromium carbide (Cr₂C₃), aluminium oxide (Al₂O₃), zirconium Oxide (ZrO₂), chromium oxide (Cr₂O₃), Stellite alloys and high-Cr/Ni stainless steel alloys such as NAH 3.5, Ni-based alloys containing Cr, Si & B such as Diamalloy 2001 and tool steel powders like M2 and the second material is one of Co, Ni, Cu, bronze, brass, monel or NiCr.
